(19) United States
(12) Patent Application Publication
(10) Pub. No.: US 2025/0235928 A1
(43) Pub. Date: Jul. 24, 2025

(54) ELECTROKINETIC BEAM DEPOSITION (EKBD) OF METALLIC PARTICLES

(71) Applicant: HARRISON B. TRACY, MENDHAM, NJ (US)

(72) Inventor: HARRISON B. TRACY, MENDHAM, NJ (US)

(21) Appl. No.: 19/025,946

(22) Filed: Jan. 16, 2025

Related U.S. Application Data
(60) Provisional application No. 63/622,137, filed on Jan. 18, 2024.

(51) Int. Cl. B22F 10/28; B22F 12/00; B22F 12/52; B33Y 10/00; B33Y 30/00

(52) U.S. Cl. CPC B22F 10/28; B22F 12/224; B22F 12/52; B33Y 10/00; B33Y 30/00

(57) ABSTRACT

An additive manufacturing method using electrokinetic deposition of metallic particles aided by a heat input to deposit the metallic particles onto a substrate resulting in mechanical bonding of particles to the substrate and to previously deposited particles. Metallic particles are charged and positioned within the vicinity of a similarly charged stationary plate, the resulting coulombic force between the particles and the plate projects the particles away from the plate towards a substrate and upon impact the particles mechanically deform into a homogenous mass, adhering to the substrate and previously deposited particles. Particles are selectively deposited according to their position opposite the substrate and are deposited to synthesize an additively manufactured part according to the desired shape of the part. The shape of the part is determined by a computer aided manufacturing program which programs the operation of the invention to synthesize the part according to a digital 3D file.

### CROSS-REFERENCE TO RELATED APPLICATIONS

The present application is non-provisional of, and claims the benefit of, U.S. Patent Application Ser. No. 63/622,137 filed Jan. 18, 2024, entitled “ELECTROKINETIC BEAM DEPOSITION (EKBD) OF METALLIC PARTICLES,” the disclosure of which is hereby incorporated by reference herein.

### BACKGROUND OF THE INVENTION

Currently in the additive manufacturing/3D printing market (terms 3D printing and additive manufacturing are used interchangeably herein), metal 3D printing methods exist in a variety. In short summation, there are powder bed processes, where layers of metal powder are rolled on top of the previous layer, then a pattern is sintered or melted with a laser creating a solid mass. There are direct deposition methods, where powdered metal is deposited through a nozzle that traces the shape of a layer of the printed part, and the powder is immediately sintered or melted to form a solid mass. There is also a cold spray process, in which particles are fired through a nozzle at very high speeds (around Mach 1 and faster) onto a substrate where they plastically deform and create mechanically interlocking bonds with other deposited particles. These technologies offer the capability to produce parts with designs and complexities that would otherwise have been impossible with traditional subtractive methods of manufacturing, however, they struggle to enable the production of such parts on a mass production scale.

The issue seen here is one of throughput, meaning the speed at which a 3D printer synthesizes a part. These technologies listed above are inhibited by features of their design that present themselves as bottlenecks to the speed and volume of production, severely limiting the possible operational output of additive manufacturing. For instance, the powder bed processes require that between each layer produced, a rolling head must pass over the sintered layer depositing a new powder layer every single time. This process takes multiple seconds, and this time wasted massively accumulates when applied between thousands of layers for a single batch. With the direct deposition methods using the nozzle, the bottleneck is that the parts can only be produced as fast as the nozzle can move, deposit material, and sinter or melt the material together. Nozzles can be described as slow-point, single-input sources as they do not move particularly fast, and they can only work on a single point in a single layer at a single instant. Again, this is not conducive to high throughput. Finally, although cold spray processes are capable of large quantities of mass per unit time production relative to other metal additive manufacturing methods, they are still confined to the use of a nozzle as an input method, and therefore suffer from the same bottleneck in throughput.

Another throughput related issue that the additive manufacturing industry has not addressed is the printing of parts one layer at a time.

For example, looking further at cold spray, it should be noted that this is the additive manufacturing method most like the new process describe herein, and that the bonding mechanism (high speed collisions resulting in plastic deformation) between metal particles is similar.

### SUMMARY OF THE INVENTION

The difference described in the process herein is the removal of the slow-point, single-input nozzle and to enable the projection of metal particles from any point opposite the substrate (build plate) at any time during the printing process, thus allowing for the synthesis of multiple layers simultaneously. Such capabilities will greatly contribute to the increased throughput offered by this EKBD process compared to other additive manufacturing methods. The synthesis of multiple layers simultaneously can be referred to as multi-layer synthesis.

In this application, the term “projection” is referred to when indicating the forced movement of metallic particles, and the term “deposition” is referred to when indicating a kinetic impact and fusion of particles onto a substrate. Also, terms “printing,” “growing,” and “synthesizing” all refer to the 3D printing process where the invention described creates a three-dimensional part. Also, the term “throughput” refers to the rate at which an additive manufacturing machine can create a part or multitudes of parts from start to finish.

As indicated above, there is a present need in the industry and broader markets for higher throughput additive manufacturing. The process described herein will allow the projection of particles from any point opposite the substrate at any time during the printing process. This directly addresses the overall problem facing the additive manufacturing industry, being the throughput issue. No additive manufacturing method has been able to produce parts at a rate or economy competitive with traditional subtractive manufacturing methods or injection/casting-based methods. The process described herein will enable mass production, high-throughput additive manufacturing. This process is called Electrokinetic Beam Deposition (abbreviated as EKBD).

Electrokinetic Beam Deposition (EKBD) is a metallurgical additive manufacturing method which presents a significant improvement to a preexisting metallurgical additive manufacturing method known as cold spray. The primary objective of the method described herein is to provide a high-throughput alternative to the current metallurgical additive manufacturing methods, opening opportunities for mass production additive manufacturing.

An exemplary description of one embodiment of the process described herein is as follows: a small metallic particle is given a positive or negative charge. A fixed projection plate (situated opposite a substrate) is given a similar, but greater charge. When positioned in close proximity to the projection plate, the like charges between the particle and projection plate results in a strong, repulsive coulomb force. Should the charges be of sufficient magnitude, the particle will be projected away from the vicinity of the projection plate through the air, an inert gas environment, or a vacuum, toward the substrate, colliding with it. The strength of the coulomb force determines the particles projection velocity, and this force is a function of the magnitudes of the charges induced on the particle and the projection plate. Larger charges on the particle and the projection plate (measured in coulombs) will result in a larger projection velocity of the particle. During the projection of a particle, a heat input (can be a laser capable of heating a surface) is used to heat the surface of the collision point of said particle to induce a softening effect (like an austenitic phase transformation), making plastic deformation between the particle and the substrate easier. As the layers of deposited particles build up, successive collisions between particles will result in the same plastic deformations, resulting in the formation of a homogeneous mass comprising the part being printed. Furthermore, another projection plate with a charge opposite that of the particles can be placed behind the substrate in relation to the path of the projected particles so as to increase the coulombic force acting on the particle by attracting the particle toward the substrate. This results in a pushing and pulling effect on the particle, with the objective of exerting more force on the particle (such an arrangement is not seen in the images provided but is still outlined in this paper). The substrate itself can also have a charge induced on it to further enhance particle projection speeds.

An exemplary description of one embodiment the operation of the process described herein is as follows: the procedure for printing a part must be determined through dissecting a 3D model of the part with CAD/CAM software that then writes an automated procedure for the printing machine to follow as it prints the part. This procedure is commonly referred to in the additive manufacturing industry as “slicing” the part or breaking it down into two dimensional layers of some standard thickness. After the machine has the automated procedure to follow, the printing process will begin. First, and in no particular order, the heat input sources are powered on, the projection plate(s) and possibly substrate are charged, and the loading conveyor belt (or delivery method in which large quantities of the metal particles are brought to the projection area) will begin to be loaded with the small metallic particles from a hopper or other feedstock container/source. As the loading conveyor belt moves the particles over the projection plate, they rest in contact with a wire which is connected to inductor plates (or some method of charging the particles and plates such as using a Van de Graaf generator). As the particles approach the point of projection, which is predetermined by the slicing procedure at the beginning, they will be rapidly charged so that they will be projected due to the repulsive coulomb force between the particle and the charged projection plate that is in close proximity to the charged particle. As the particles are projected, the heat input will heat the surface on the substrate of the collision point between the particle and the substrate. This heating should be enough to heat the surface so that a softening effect is induced, making plastic deformation between the particle and the substrate easier, creating stronger mechanically interlocking bonds. As this cycle continues, the substrate is connected to a threaded rod which, when actuated by a stepper motor, raises the substrate, allowing for more successive layers to be printed.

Further capabilities of the exemplary process of this embodiment should also be described. To support overhang features of printed parts, this process is capable of printing supports which should be easily removable, for instance using a Dremel cutting wheel, pliers, etc. Printing overhang features can also be supported by rotating the orientation of the substrate relative to the projection plate. This would allow the particles to project into the side of the printed part. Such a capability will allow the printing process to not only print upward (vertically), but if the design permits, to print outward and upward. Again, so long as the design permits, this can help to avoid the need for printed supports, reducing any necessary post processing operations. This can further contribute to greater throughput and less costly production in larger quantities. This can be accomplished by mounting the substrate on a multi-axis joint which is connected to the threaded rod.

This invention as described through the aforementioned embodiments and others therefore serves as a high throughput metal additive manufacturing method. This would allow the mass production of metal parts with designs and geometric complexities that were otherwise impossible/extremely difficult for traditional subtractive manufacturing methods. To summarize in one sentence, this invention combines the design freedom of additive manufacturing with the throughput of traditional mass production methods. Aside from the broad scope of that declaration, this technology serves a major improvement to the preexisting cold spray process, in which the elimination of the use of a slow-point, single input nozzle can allow for greater throughput and enables batch production. This means that multiple parts can be synthesized at a single instant if they can fit within the build space of the machine.

The EKBD technique of the present invention is designed to overcome the deficiencies of conventional 3D printing/additive manufacturing, and are summarized generally below. Note that while various methods may be provided with steps in particular orders, those orders are not to be considered the only order in which the various methods may be conducted and same may be conducted in any practical order.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the particle projection belt is moveable.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the particle projection belt is moveable via rotation around rollers.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the displacement is through one of air, an inert gas environment or a vacuum.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; where the metallic particles are between 100 microns and 2 millimeters in diameter.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a hopper adapted to feed the metallic particles into the plurality of embossments.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a substrate, wherein a displaced metallic particle is displaced onto the substrate.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a substrate, wherein a displaced metallic particle is displaced onto the substrate; further comprising a laser adapted to heat either or both the substrate and the displaced metallic particle.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a substrate, wherein a displaced metallic particle is displaced onto the substrate; further comprising a laser adapted to heat either or both the substrate and the displaced metallic particle; wherein the laser directly or indirectly imparts heat into the metallic particle or substrate sufficient to induce thermal softening.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a hopper adapted to feed the metallic particles into the plurality of embossments; wherein the hopper is arranged with a single row of metallic particles.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the first charge is induced selectively via wires connected to an inductor plate.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein metallic particles are continuously displaced such that a three-dimensional printed article is created.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein a plurality of particles are displaced, and wherein the additive manufacturing device further comprises a laser adapted to heat the displaced metallic particles to induce thermal softening and create a three-dimensional article.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the metallic particles are of different dimensions.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the particle projection belt contains a first side supporting metallic particles and an opposite second side, and wherein the charged electrode projection plate is adjacent the opposite second side.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; wherein the particle projection belt contains a first side supporting metallic particles and an opposite second side, and wherein the charged electrode projection plate is adjacent the opposite second side; further comprising a substrate, wherein the substrate is adjacent the first side of the particle projection belt.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a substrate, wherein a displaced metallic particle is displaced onto the substrate; wherein a distance and orientation between the substrate and the particle projection belt is adjustable.

In one embodiment of the invention, an additive manufacturing device includes a particle projection belt having a plurality of embossments sized and configured to support metallic particles, each of the plurality of embossments configured to selectively receive a first charge at a given polarity; a charged electrode projection plate adapted to present a second charge at the given polarity to the particle projection belt; wherein, when at least one of the plurality of embossments receives the first charge while the charged electrode projection plate receives a second charge, the metallic particle supported in the embossment is displaced out of the embossment; further comprising a computer controller adapted to selectively provide each of the plurality of embossments with the first charge at a given polarity.

In one embodiment of the invention, a process for additive manufacturing, wherein metallic particles are projected onto a substrate via electrostatic repulsion resulting in the plastic deformation and homogenization of particles into a net mass, includes dispensing at least one metallic particle into at least one of a plurality of embossments provided on a particle projection belt; selectively electrostatically charging the metallic particle and a projection plate located adjacent the particle projection belt with charges of the same polarity thereby causing the metallic particle to be displaced from the particle projection belt via electrostatic repulsion.

In one embodiment of the invention, a process for additive manufacturing, wherein metallic particles are projected onto a substrate via electrostatic repulsion resulting in the plastic deformation and homogenization of particles into a net mass, includes dispensing at least one metallic particle into at least one of a plurality of embossments provided on a particle projection belt; selectively electrostatically charging the metallic particle and a projection plate located adjacent the particle projection belt with charges of the same polarity thereby causing the metallic particle to be displaced from the particle projection belt via electrostatic repulsion; further including dispensing at least one metallic particle into a plurality of embossments provided on the particle projection belt; selectively electrostatically charging at least some of the plurality of embossments provided on the particle projection belt with charges of the same polarity thereby causing the plurality of metallic particles to be displaced from the particle projection belt via electrostatic repulsion.

In one embodiment of the invention, a process for additive manufacturing, wherein metallic particles are projected onto a substrate via electrostatic repulsion resulting in the plastic deformation and homogenization of particles into a net mass, includes dispensing at least one metallic particle into at least one of a plurality of embossments provided on a particle projection belt; selectively electrostatically charging the metallic particle and a projection plate located adjacent the particle projection belt with charges of the same polarity thereby causing the metallic particle to be displaced from the particle projection belt via electrostatic repulsion; further including dispensing at least one metallic particle into a plurality of embossments provided on the particle projection belt; selectively electrostatically charging at least some of the plurality of embossments provided on the particle projection belt with charges of the same polarity thereby causing the plurality of metallic particles to be displaced from the particle projection belt via electrostatic repulsion; wherein the displaced metallic particles are displaced onto a substrate.

In one embodiment of the invention, a process for additive manufacturing, wherein metallic particles are projected onto a substrate via electrostatic repulsion resulting in the plastic deformation and homogenization of particles into a net mass, includes dispensing at least one metallic particle into at least one of a plurality of embossments provided on a particle projection belt; selectively electrostatically charging the metallic particle and a projection plate located adjacent the particle projection belt with charges of the same polarity thereby causing the metallic particle to be displaced from the particle projection belt via electrostatic repulsion; further including dispensing at least one metallic particle into a plurality of embossments provided on the particle projection belt; selectively electrostatically charging at least some of the plurality of embossments provided on the particle projection belt with charges of the same polarity thereby causing the plurality of metallic particles to be displaced from the particle projection belt via electrostatic repulsion; wherein the process is repeated to create a three-dimensional article.

In one embodiment of the invention, a process for additive manufacturing, wherein metallic particles are projected onto a substrate via electrostatic repulsion resulting in the plastic deformation and homogenization of particles into a net mass, includes dispensing at least one metallic particle into at least one of a plurality of embossments provided on a particle projection belt; selectively electrostatically charging the metallic particle and a projection plate located adjacent the particle projection belt with charges of the same polarity thereby causing the metallic particle to be displaced from the particle projection belt via electrostatic repulsion; further including dispensing at least one metallic particle into a plurality of embossments provided on the particle projection belt; selectively electrostatically charging at least some of the plurality of embossments provided on the particle projection belt with charges of the same polarity thereby causing the plurality of metallic particles to be displaced from the particle projection belt via electrostatic repulsion; wherein the displaced metallic particles are displaced onto a substrate; wherein the displaced metallic particles or substrate are heated via a laser to induce thermal softening.

In one embodiment of the invention, a process for additive manufacturing, wherein metallic particles are projected into a substrate via electrostatic repulsion resulting in the plastic deformation and homogenization of particles into a net mass, includes dispensing a plurality of metallic particle into a first plurality of embossments provided on a moveable particle projection belt, wherein each of the plurality of embossments receives a maximum of one metallic particle; moving the rotating particle projection belt to reveal a second plurality of embossments provided on the moveable particle projection belt; dispensing a plurality of metallic particles into the second plurality of embossments provided on the moveable particle projection belt, wherein each of the second plurality of embossments receives a maximum of one metallic particle; selectively electrostatically charging certain of the plurality of metallic particles and a projection plate located adjacent the moveable particle projection belt with charges of the same polarity thereby causing the certain of the metallic particles to be displaced from the rotating particle projection belt via electrostatic repulsion.

In one embodiment of the invention, a process for additive manufacturing, wherein metallic particles are projected into a substrate via electrostatic repulsion resulting in the plastic deformation and homogenization of particles into a net mass, includes dispensing a plurality of metallic particle into a first plurality of embossments provided on a moveable particle projection belt, wherein each of the plurality of embossments receives a maximum of one metallic particle; moving the rotating particle projection belt to reveal a second plurality of embossments provided on the moveable particle projection belt; dispensing a plurality of metallic particles into the second plurality of embossments provided on the moveable particle projection belt, wherein each of the second plurality of embossments receives a maximum of one metallic particle; selectively electrostatically charging certain of the plurality of metallic particles and a projection plate located adjacent the moveable particle projection belt with charges of the same polarity thereby causing the certain of the metallic particles to be displaced from the rotating particle projection belt via electrostatic repulsion; further comprising a substrate and a laser, wherein displaced metallic particles or the substrate are heated via the laser to induce thermal softening.

### BRIEF DESCRIPTION OF DRAWINGS

The subject matter regarded as the invention is particularly pointed out and distinctly claimed in the concluding portion of the specification. The invention, however, both as to organization and method of operation, together with features, objects, and advantages thereof, will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

With respect to the drawings, FIG. 1 is a cross-sectional diagrammatic view of an EKBD process in accordance with one embodiment of the present invention, showing the lifecycle of a particle as it travels from beginning to end of the process.

FIG. 2A is an isometric view showing one version of an apparatus used to make the inventive process possible.

FIG. 2B is a top view of the isometric image from FIG. 2A which displays a hidden motor.

FIG. 3 is a close-up, cut-out section, isometric depiction of what a version of the surface of the loading conveyor belt could possibly look like.

FIG. 4 is an isometric depiction of what a version of the particle loading hopper could possibly look like.

FIG. 5 is an isometric view showing one version of the apparatus used to make the process possible with one possible orientation of the hopper used to deposit particles onto the conveyor belt. In this figure, the belt does not depict the surface displayed in FIG. 3.

FIG. 6A is one possible representation of the inductor plate set-up. What is visible is a cut out portion of the belt connected by wiring to two plates which are separated by a small distance from one another. One plate is charged and then insulated, while the other is connected to the particles via the wiring seen in the image. This connection is controlled through a switch on a circuit board, which is further controlled by a computer.

FIG. 6B is a modelled representation of the inductor plate set-up in relation to the conveyor belt and the brushes on the surface of the belt in accordance with aspects of the invention.

FIG. 6C is an isometric view of an exemplary inductor plate set-up.

FIG. 7 is an exemplary operational flow chart describing the steps taken during an operational cycle of the machine, in accordance with aspects of the invention.

FIG. 8 is an exemplary depiction of the inductor plate set-up. It is also a zoomed in version of the inductor plate portion from FIG. 6.

FIG. 9 is an exemplary process flow chart for the induction charging procedure of the inductor plate set-up and the particles which rest on the conveyor belt, in accordance with aspects of the invention.

FIG. 10 is a circuit representation of an exemplary inductor plate set-up, in accordance with aspects of the invention. The connection between the inductor and the particles and the ground is controlled by a changeover switch.

### DETAILED DESCRIPTION OF THE INVENTION

In the following are described the preferred embodiments of the devices and procedures providing ELECTROKINETIC BEAM DEPOSITION (EKBD) OF METALLIC PARTICLES in accordance with the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. Where like elements have been depicted in multiple embodiments, identical reference numerals have been used in the multiple embodiments for ease of understanding.

It is specifically noted that the detailed description will describe one or more processes out of many processes embodied by the present invention. Likewise, the images provided do not encompass the entirety of every possible inventive image, but are representative of the descriptions offered in the application herein, as the images display one possible version of what a machine supporting the process in this application can take the form of. Even at the time of writing other possible embodiments exist.

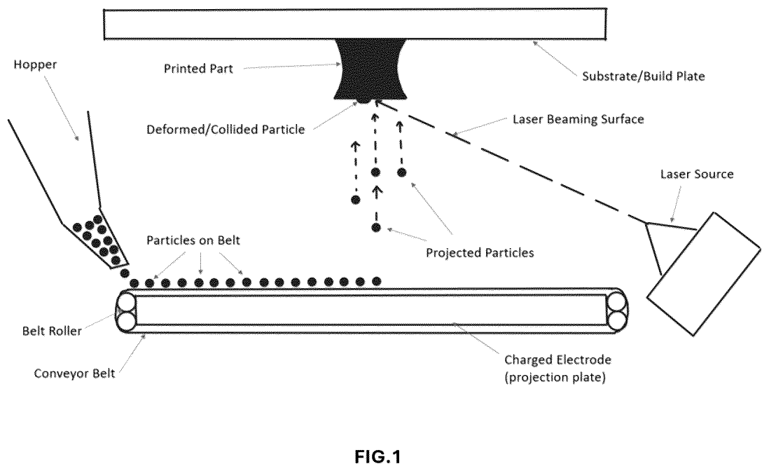

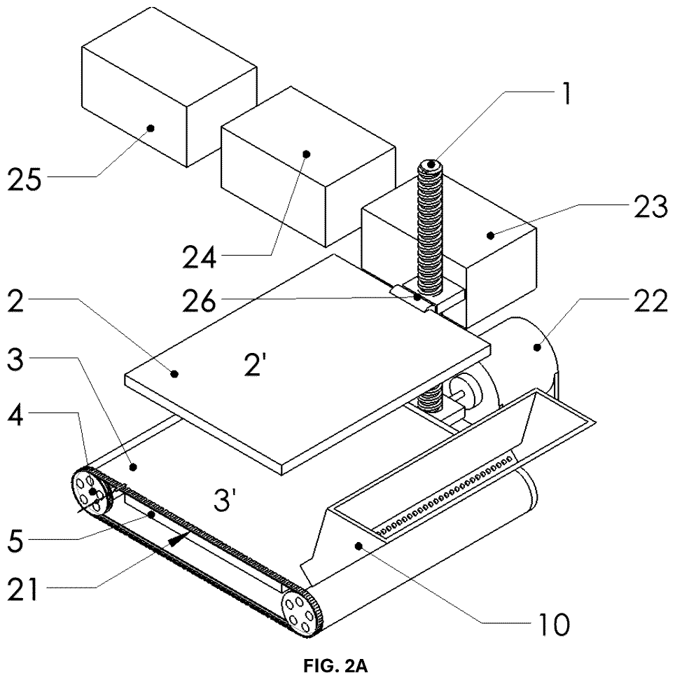

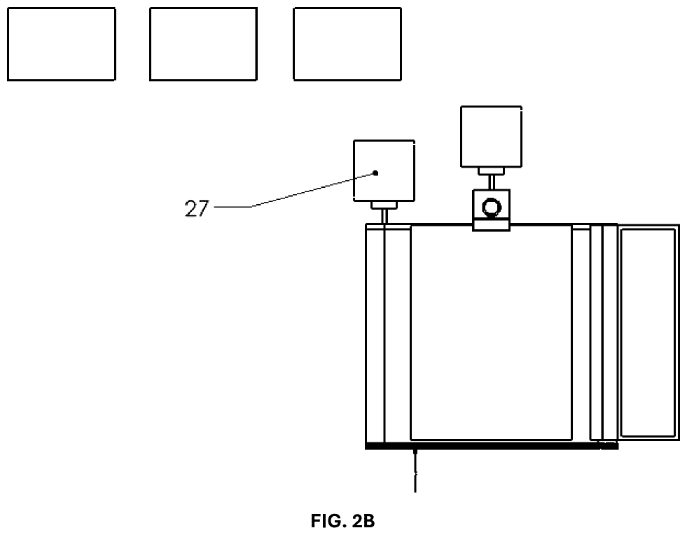

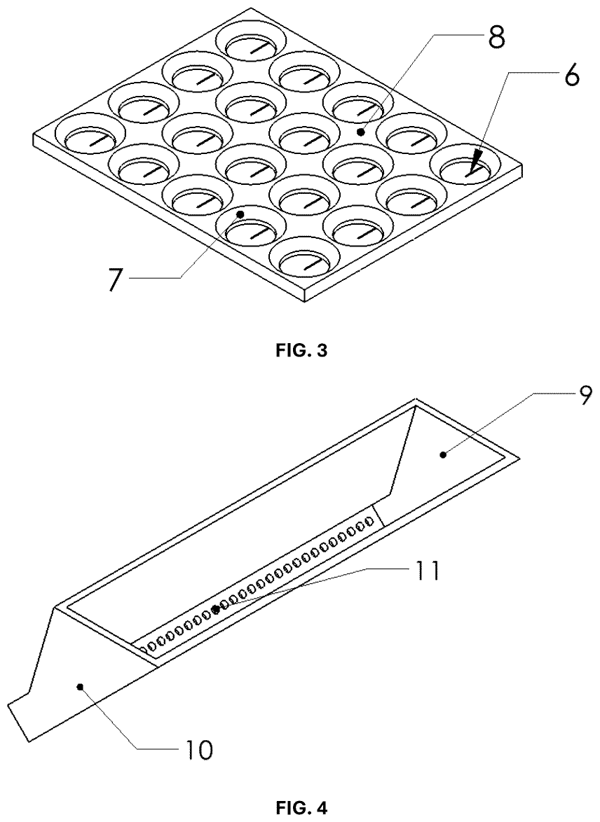

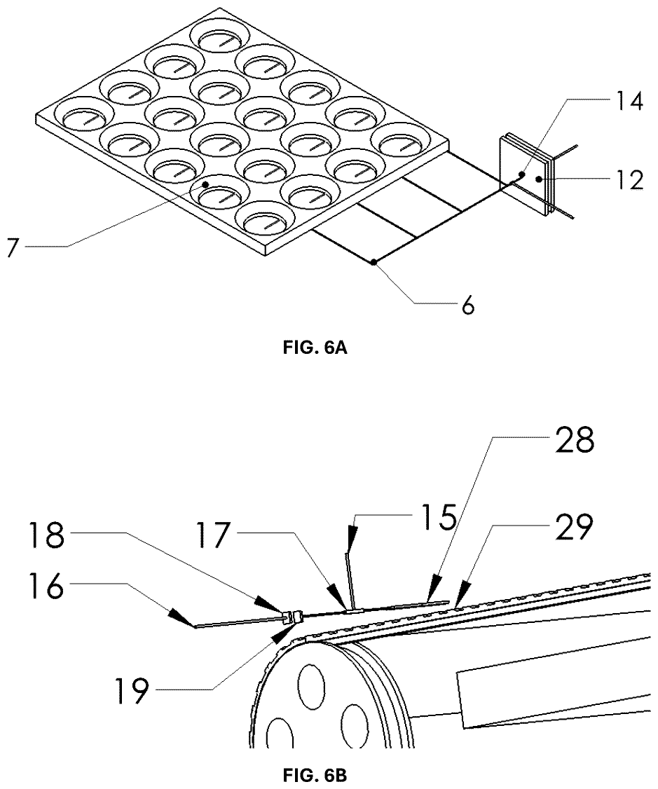

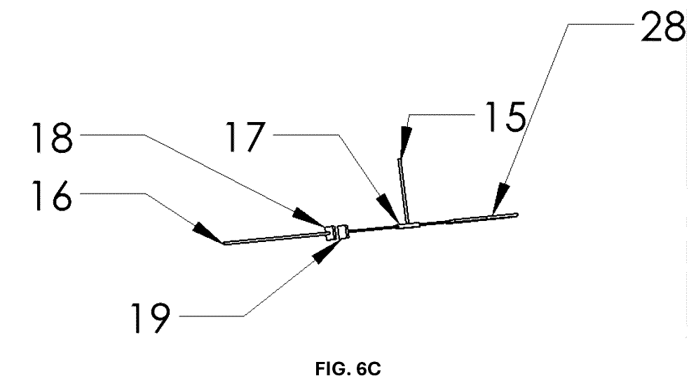

Starting with FIG. 2A, and in accordance with one embodiment of the present invention, a threaded rod 1 supports a substrate 2 which is attached to a multi-axis articulating mechanism 26 allowing for the rotation of the surface 2′ of the substrate 2 in the X and Y planes relative to the surface 3′ of a particle projection belt 3. This belt 3 is mounted on rollers 4 which are driven by a continuous electric motor 27 (see FIG. 2B), preferably a continuous DC motor, and said belt 3 is situated so that its surface 3′ is very close to, but not touching a charged electrode 5 also known as the projection plate, preferably within the range of 1 mm, such that the charged electrode 5 can influence charged particles on the belt 3. Although shown as a continuous belt rotating around said rollers 4 in a closed loop, in other embodiments the particle projection belt 3 may be a linear belt either moving in a single direction or having the ability to oscillate. Situated above and to the side of the belt 3, so as not to be within the space between the belt 3 and the substrate 2, is a hopper 10. This hopper 10 dispenses small metallic particles onto the belt through holes 11 (see FIG. 4) at the bottom of the hopper 10, on corresponding recessed wells 7 (embossments) built into the belt (see FIG. 3). These embossments 7 are structured to contain a dispensed metallic particle and maintain its positional consistency relative to the surface of the belt 3 as it rolls. The surface 8 of the belt is simply unused space between embossments. At the bottom of these embossments 7 is a wire 6 (see FIG. 3) that is used to charge the particles as they rest in contact with the wire 6 in the embossments 7 on the belt. The charged electrode 5 is charged by an external charging source 24 and is connected to a coulomb meter 25, which is also connected to a computer controller 23, which can send signals to the external charging source 24 indicating if charge adjustments need to be made for the electrode 5. The wires 6 embedded into the belt 3, which are in contact with the particles when deposited, are individually connected to a circuit board, that is an internal component of the computer controller 23, which activates switches 17 (see FIG. 6B) controlling the circuitry of inductor plates 12 (see FIG. 6A) which connect to a series of wires 6 in the belt 3. The inductor plates 12 are rechargeable plates where one plate maintains a constant charge and the other periodically discharges to charge corresponding particles for projection, and they induce enough electrostatic charge to charge a multitude of particles at a single instant by only being in contact with a certain portion of wires 6 in the belt 3, which can be controlled by the circuit board inside the computer controller 23 as to whether they are in contact with the inductor plates 12 or not, allowing charging through induction for their respective particles. Many inductor plates 12 are to be connected to the wires 6 (despite only displaying one in the images) in the belt 3 to ensure that every deposited particle can be charged and then projected. The inductor plates 12 used in this process are controlled through the circuit board in the computer controller 23, and the timing of the switches is further controlled by a CAD/CAM program. These programs will determine the timing of the activation of the switches 17 to control when particle projection occurs, which is further determined by the shape of the part being printed by where and when the particles need to be projected to make that shape.

Various means may be used when depositing particles on the belt 3 by the hopper 10. Firstly, a hopper does not necessarily need to be used for this part of the process, particles can be loaded through a variety of means so long as they are placed into one of the embossments 7 and can then be charged and projected. Some form of hopper is preferred as the timing and position of a depositing particle can be controlled. Said control can be achieved through a mechanized hopper in which particle flow is controlled. Multiple hoppers may also be utilized.

Preferably during operation, any motor such as motors 22 and 27 involved in the process is computer controlled to ensure the consistent timing of operations. This would also enable the computer to make changes to overall printing rates.

The preferable actuation of the threaded rod 1 is accomplished using a stepper motor 22, in which the height of the substrate 2 can be incrementally controlled and accurately held in place.

The substrate 2 does not necessarily need to be made of a metal which can achieve an austenitic phase transformation under certain conditions, the substrate can be made of any material in which the high velocity impact of a particle would result in the adequate bonding between the two surfaces, enough so to support the growing weight of a printed part as it is built up layer after layer.

The material composition of the charged electrode 5 is also not prohibited to any specific metal. It should be composed of a material in which strong enough charges can be held so that high enough speeds of projection of the particles is attainable. Furthermore, the size and shape of this electrode 5 is also not prohibited to any specific dimensions, rather a shape that optimizes the charge that can be held by the electrode 5, but so long as it can project particles into a build-space defined by the area of the substrate 2. This means that the electrode 5 would have to mirror the shape of the substrate 2 that rests opposite of it, or at least have an operational area larger than that of the substrate 2 in the X and Y directions. The Z direction for the build space is variable as the height of the build will increase throughout the duration of the “growing” process of the part being synthesized.

In a preferred embodiment, the material composition of the charged electrode is copper, aluminum, or material capable of bearing sufficient charge while its size is between 100 microns and 2 millimeters in diameter.

The deposition of the particles into the described embossments 7 as the belt rolls under the hopper 10 is achieved according to a computer program. Not every single embossment 7 is to be loaded with a particle as the belt passes. Because an individual inductor plate setup (the inductor plates with its corresponding set of embossments) of FIG. 6A is used to charge a multitude of particles, particles must be deposited into their respective embossments 7 according to the shape of the layer they are being deposited into. This means that an inductor plate setup of FIG. 6A might be responsible for charging particles in a group of embossments in which some of the embossments 7 are not positioned to project a particle into the printed parts layer during that pass of the belt, so this embossment should not be loaded with a particle, because otherwise the shape of the printed layer might exceed its predetermined bounds and the part would be ruined. To avoid depositing particles where they are not wanted, the hopper 10 will simply omit loading any embossments 7 during that pass of the belt 3.

The multi-axis articulating mechanism 26 is actuated by motors which are computer controlled. This mechanism must provide a functionality in which the substrate 2 can be angled relative to the charged electrode 5 up to angle of at least +/−90 degrees. Such angles should be achievable to reduce the necessity for printing overhang supports. However, overhang supports should be a functionality that is still included in the printing process, which can easily be removed after printing. Rotation of the substrate 2 up to +/−90 degrees can allow for the printed part to be “built up” in several different directions. For example, this method would allow for an L-shaped part to be printed, where the top of the L can be printed directly on the substrate 2, and then substrate 2 can rotate to allow the bottom of the L to be printed onto the portion printed prior, removing the necessity for support material to be printed. This functionality allows for greater design freedom for parts printed using this process.

The embossments 7 mentioned and displayed in the drawings are not finalized in terms of shape or form. The shape and form of these embossments, which can either be embossed or debossed structures on the surface of the belt 3 can take any form that allow for the particle to rest on an embedded wire 6 and that also holds the particle in place maintaining its positional consistency as the belt moves around (ensuring the particle does not roll across the surface of the belt as it moves). Furthermore, the shape of the embossments 7 must permit the particle to freely project once it is charged, and provide no hindrance on the travel, direction, or velocity of the particle as it is projected. Such projection must be done in a direction that is directly perpendicular to the surface of the belt. In preferred embodiments, the embossments 7 are circular, as shown in FIG. 3.

As belt 3 travels, the projections of the particles taking place will induce a reactive force on the belt. This may cause a bending motion on the belt 3, which means that the projection angle of following particles will be affected and no longer be strictly perpendicular to the surface of the substrate 2. This dictates that the belt must be made of a material or be supported in a fashion in which there is limited to no bending motion taking place because of the projections. This is necessary to maintain projection accuracy of the particles into their desired collision locations. It should be noted that the projection angle for every particle should be precisely 90 degrees to the surface of the belt 3, or perfectly perpendicular to the surface of the belt and to the surface of the substrate 2. Keeping the belt 3 taught is one option and taught enough so that the forces of the projections are insufficient to cause bending. Another available option is to provide rolling supports for the belt 3 as it rolls over the electrode 5, which does not impede the electrostatic forces between the particles on the belt 3 and the electrode 5. Using the method of keeping the belt 3 taught as it rolls along is one of the methods possible and is used in the drawings used in this application.

The wires 6 embedded in the belt 3 are channeled and grouped into contact points. For instance, 100 wires representing a 10×10 grid of particles will represent one group. These wires 6 are channeled together to a single connection with a switch 17. This switch 17 determines whether the connection of the inductor plate setup 12 is to the circuit board inside of the computer controller 23 or to the brush connections 28 and 29 (see FIG. 6B). This grouping will continuously be charged, and then discharged according to a computer program when the respective particles are to be projected. The induction process and subsequent activation of circuit switches 17 will result in charged particles allowing for projection. The individual inductor plate 19 in FIG. 6B will then be grounded then ungrounded so that the cycle can repeat, while inductor plate 18 is kept at a constant charge. Furthermore, the wires should be able to withstand the cyclical bending and unbending associated with the belt being rolled around the rollers 4.

The electrode 5 is charged at the beginning of the process. It should then maintain this charge throughout the duration of the process, in which the charge is in the magnitude of 1*10\hat{ }-7 coulombs. This charge is not a finalized figure, and it is likely subject to change, but is exemplary. An anticipated change is that the charge of the electrode will be attempted to be made as large as possible, and the charges of the particles will be attempted to be made as small as possible while stilling allowing acceptable plastic deformation of particles. Doing this would help emphasize more of a vertical force on the particles, and less of a horizontal, particle to particle, repulsive force due to the like charges. The electrode should be connected to a coulomb meter 25 to monitor the charge. If any variations occur during the process, the connected external charging source 24 should adjust the electrodes 5 charge according to a signal by a computer controller 23 which is also connected to the coulomb meter 25.

External charging sources 24 and computer controllers 23 can take the form of commercially available hardware that can operate as described in the process. The coulomb meter 25 can also be a commercially available product but must also be able to send signals to the computer controller 23 during operation if the charge of the projection plate needs to be adjusted. For example, a charging sources 24 can take the form of a Van de Graaf machine generating electrostatic charges through the triboelectric effect.

FIG. 6A depicts an inductor plate wire group. This depiction does not show the actual number of particle holding spots on the belt 3 connected to the inductor plate setup seen in FIG. 6A, it simply shows a representation of what this part of the component would look like. The particle holding spots or embossments 7 as they have been referred to in preceding paragraphs will be grouped together and connected via wires 6 embedded in the belt 3 which will all be connected to a single inductor plate such as seen in FIG. 6A. During the process, one of the inductor plates is kept charged, while the other is cyclically grounded then connected with the particles. This change of connection between the ground and the particles allows for charges to be dissipated then for the induction process to repeat, inducing charges on the particles allowing them to be projected. The particles are connected to one inductor plate of the inductor plate 19 of FIG. 6B and this portion of the set-up is polarized, with opposite charges accumulating in the particles and the inductor plate that they are connected to. A switch 17 is then activated separating these two polarized segments, leaving the particles charged and ready for projection, while the inductor plate is then grounded. The charging of the particles should be as rapid as possible. Once the projection occurs and the grounding is complete, a switch will activate allowing for the inductor plate to be reconnected with new particles for the induction process to repeat. One inductor plate setup such as in FIG. 6A is responsible for charging a multitude of particles in their respective embossment 7 holding spots, and this number can vary depending on the charge that the actual inductor plates can split among particles. For example, in FIG. 6A, the inductor plates will charge twenty particles in that grouping of embossments. Furthermore, many of these inductor plate setups such as in FIG. 6A will need to be made to provide charging capabilities along the entire surface of the belt.

In reference to FIG. 8, a connection 15 to the circuit board in the computer controller 23 (not seen in FIG. 8) controls a switch 17 that allows connection between one of the inductor plates 19 and the particles resting on the belt 3 (also not seen in FIG. 8). When this switch 17 is closed, plate 19 seen in FIG. 6B forms a circuit with the particles resting on the wires 20 embedded in the belt 3. The resulting effect from the charged plate 18 seen in FIG. 6B causes polarization to occur between the particles and the plate 19, where plate 19 and the connected particles become oppositely charged. Once a sufficient charge is reached in the particles to induce an adequate projection velocity, the switch is activated to open the circuit, separating the particles from their connection with the plate 19, resulting with the projection of the particles and the grounding of the plate 19, hence charging by induction. The process is repeated with plate 18 seen in FIG. 6B keeping the same static charge, as it is insulated after being charged through an external power source 24 via connection wire 16. The charging capabilities of the actual inductor plate must be strong enough so that they are capable of producing charges in the particles sufficient for projection with almost immediate effect from the moment the charging of the particles begins.

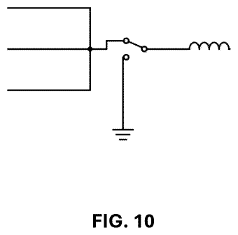

FIG. 10 depicts a simplified circuit of the inductor plates. The connection of the inductor plate to the particles or to the ground is controlled by a changeover switch. This switch is controlled by a circuit board inside the computer controller. Furthermore, the three parallel wires 6 on the left-hand side of the circuit represent connections to particles, which are not depicted in this image. In reality, the parallel wires will be much more numerous so as to connect the inductor plates to many more particles such as depicted in FIG. 6A. For the sake of simplicity, the circuit shows the inductors connected via switch to a multitude of particles.

The ideal number of inductor plate setups such as in FIG. 6A that would be used is yet to be finalized. A larger quantity of these setups will allow for more freedom with regards to projecting more particles at various points in time, however, this would require greater computing power. For example, the belt is split into quarters, 4 inductor plate setups would be used to charge the four quarters, or one inductor plate setup per section on the belt. Determining the number of particles that one set of inductor plates will charge will be based on the electrostatic charge capabilities of the plates themselves, meaning a pair of plates will be responsible for charging whatever number of particles they can feasibly induce a strong enough charge in to result in projection of said particles. This is also dependent on the size of particles used in the projection process.

Brushes 29 (See FIG. 6B) attached to the outer surface of the insulative conveyor belt 3 are made of conductive material. These brushes are connected to the wiring embedded in the conveyor belt, which lead to the embossments 7 where the particles rest before projection occurs. What is seen in the images is not a final model of the brush and inductor plate setup seen in FIG. 6A, rather it is meant to display the principal elements of the components in this document.

FIG. 6B sees a floating arrangement of the inductor plate setup in relation to the particle conveyor belt 3. The brush contact points 28 and 29 will be in contact as the belt rotates and contact point 28 (which is in fixed position) will continually meet successive contact points 29 as the belt rotates around. This will enable the inductor plates to service a designated portion of the belt in relation to the substrate 2 as it rotates around. Without the brush connection, the inductor plate set-ups 12 would have to rotate around with the belt, and this would be inconvenient. Brush 28 has filleted edges to avoid snagging between the contact points on the belt and the inductor plates. Wire 15 is a grounding wire, and it is connected to the secondary inductor plate 19 (see FIG. 8) via a changeover switch 17. This switch controls the connection of the secondary inductor plate 19 with either the grounding wire 15 or the brush connection 28 depending on the position of the switch. The primary inductor plate 18 is connected via wire 16 to an external charging source 24. This plate 18 is charged at the beginning of the process and has its charge monitored by a coulomb meter 25 during the process so that any adjustments can be made to ensure a consistent charge. The brush contact point 28 and 29 are separated in FIG. 6B to emphasize the components but are always in contact during the operation of the machine. Furthermore, the inductor plates in this image are not to scale. The brush contact points are also subject to change with regards to scale, shape, quantity and even mode of contact.

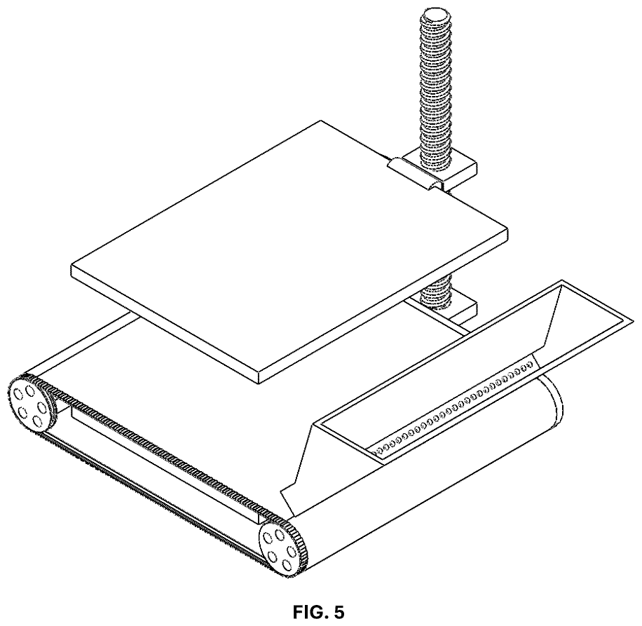

FIG. 5 displays the assembly without external components as seen in FIG. 2A. This means that the components in the image will be constructed on and around the same platform. This further indicates the external components, which are connected to the main apparatus displayed in FIG. 5, are free to be positioned at the greatest convenience, so long as the connecting wires for the external components to the main apparatus do not impede the operation and efficiency of the main apparatus during operation.

In general terms, FIG. 1 displays a cross-sectional view of what the process looks like. It should be noted that none of the components in the drawing are to scale, it is simply a diagrammatic aid to support understanding of the process. An important element included is the laser source. This is an external component of the machine, and it can take any form so long as it is capable of heating the surface of the substrate and/or printed part inducing thermal softening such as an austenitic phase transformation. The laser beam is controlled and directed by reflective mirrors, which can be actuated in a way that directs the beam to a desired location on the substrate. The laser(s) can be commercially available lasers that have the desired capabilities, for example, a 5 watt diode laser offered by Laser Tree (LT-40 W-AA) can be used to beam the surface and heat, Laser Tree also offers higher powered lasers (in terms of wattage) which can be used for faster heating if necessary.

It is anticipated that various changes and modifications may be made in the design, construction and operation of the apparatus disclosed herein for development of the process, which will be accomplished without departing from the spirit or scope of the process disclosed herein. Indeed, although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

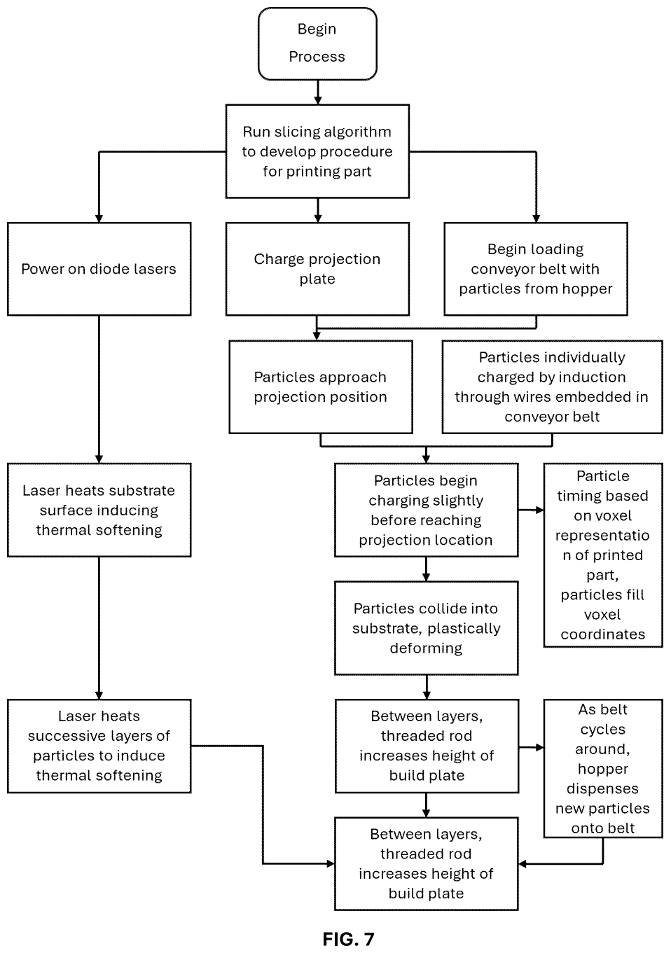

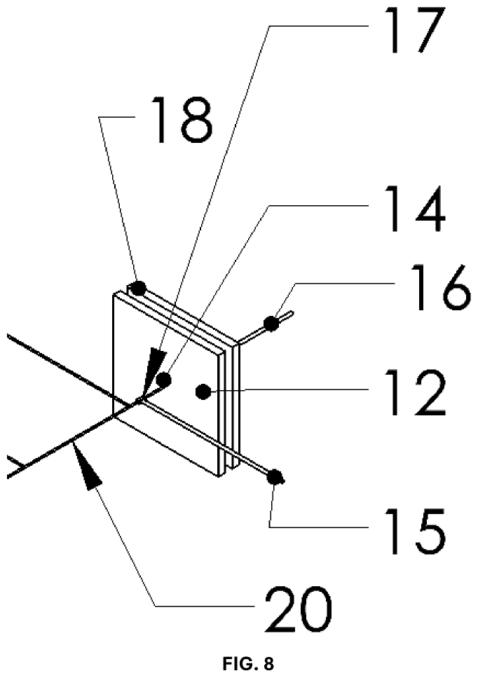

FIG. 7 represents a flow chart of the process described in steps for one embodiment of the process described herein. It is a comprehensive overview of all steps involved in the 3D printing process pertaining to the process described herein. Beginning the process, a 3D digital representation of the desired part to be printed must be processed so that instructions can be generated by the CAD/CAM software for the printing machine to use. The machine must prepare to run, so various parts of the machine need to be powered on or prepared accordingly, such as powering on the lasers for heat input, charging the projection plate(s), and loading particles onto the conveyor belt. The particles then need to be moved into their designated projection location by the conveyor belt and are charged when they reach said position. The charge of the particles is timed based on their positioning and the charge should reach projection level when the particle is appropriately positioned. The lasers input heat into the site of particle deposition. Projection of particles is timed according to where they will be projected onto the substrate. After this, the particles will collide into substrate or particles that were prior deposited. As particles are projected, the laser continues heat input into appropriate deposition sites. The substrate will need to be moved throughout the build process to accommodate space for the growing part being printed. As the belt cycles around, the hopper will dispense new particles for projection. The process repeats according to the instructions created by the CAD/CAM software generated until the desired part is created.

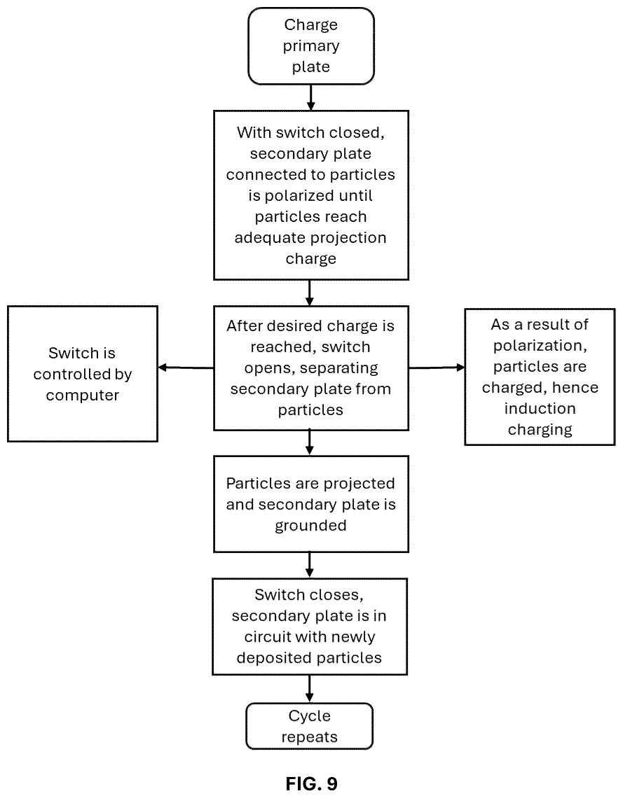

FIG. 9 similarly represents an operation flow chart describing the induction charging process for one embodiment of the process described herein, in which the example used in this case is visualized in FIG. 6C. The primary plate, item 18 in FIG. 6C is charged at the beginning of the process and is kept charged throughout the process of growing the part. The secondary plate, item 19 in FIG. 6C is polarized due to induction from the primary plate. Because the particles are connected to the secondary plate, as per FIG. 6A, the induction charging between the primary and secondary plates causes the particles to take an opposite charge of the secondary plate. The secondary plate is connected to a switch, which can ground the plate, or connect it to the particles. The secondary plate is charged and grounded according to when particles need to be charged.

1. An additive manufacturing device, comprising:
a particle projection belt having a plurality of embossments sized and configured to support metallic particles, each of said plurality of embossments configured to selectively receive a first charge at a given polarity;
a charged electrode projection plate adapted to present a second charge at said given polarity to said particle projection belt;
wherein, when at least one of said plurality of embossments receives said first charge while said charged electrode projection plate receives a second charge, the metallic particle supported in said embossment is displaced out of said embossment.

2. The additive manufacturing device of claim 1, wherein said particle projection belt is moveable.

3. The additive manufacturing device of claim 1, wherein the particle projection belt is moveable via rotation around rollers.

4. The additive manufacturing device of claim 1, wherein said displacement is through one of air, an inert gas environment or a vacuum.

5. The additive manufacturing device of claim 1, where the metallic particles are between 100 microns and 2 millimeters in diameter.

6. The additive manufacturing device of claim 1, further comprising a hopper adapted to feed the metallic particles into said plurality of embossments.

7. The additive manufacturing device of claim 1, further comprising a substrate, wherein a displaced metallic particle is displaced onto said substrate.

8. The additive manufacturing device of claim 7, further comprising a laser adapted to heat either or both the substrate and the displaced metallic particle.

9. The additive manufacturing device of claim 8, wherein said laser directly or indirectly imparts heat into the metallic particle or substrate sufficient to induce thermal softening.

10. The additive manufacturing device of claim 6, wherein said hopper is arranged with a single row of metallic particles.

11. The additive manufacturing device of claim 1, wherein said first charge is induced selectively via wires connected to an inductor plate.

12. The additive manufacturing device of claim 1, wherein metallic particles are continuously displaced such that a three-dimensional printed article is created.

13. The additive manufacturing device of claim 1, wherein a plurality of particles are displaced, and wherein said additive manufacturing device further comprises a laser adapted to heat the displaced metallic particles to induce thermal softening and create a three-dimensional article.

14. The additive manufacturing device of claim 1, wherein said metallic particles are of different dimensions.

15. The additive manufacturing device of claim 1, wherein said particle projection belt contains a first side supporting metallic particles and an opposite second side, and wherein said charged electrode projection plate is adjacent said opposite second side.

16. The additive manufacturing device of claim 15, further comprising a substrate, wherein said substrate is adjacent said first side of said particle projection belt.

17. The additive manufacturing device of claim 7, wherein a distance and orientation between said substrate and said particle projection belt is adjustable.

18. The additive manufacturing device of claim 1, further comprising a computer controller adapted to selectively provide each of said plurality of embossments with the first charge at a given polarity.

19. A process for additive manufacturing, wherein metallic particles are projected onto a substrate via electrostatic repulsion resulting in the plastic deformation and homogenization of particles into a net mass, said process comprising:
dispensing at least one metallic particle into at least one of a plurality of embossments provided on a particle projection belt;
selectively electrostatically charging said metallic particle and a projection plate located adjacent said particle projection belt with charges of the same polarity thereby causing said metallic particle to be displaced from said particle projection belt via electrostatic repulsion.

20. The process of claim 19, further comprising dispensing at least one metallic particle into a plurality of embossments provided on said particle projection belt;
selectively electrostatically charging at least some of said plurality of embossments provided on said particle projection belt with charges of the same polarity thereby causing said plurality of metallic particles to be displaced from said particle projection belt via electrostatic repulsion.

21. The process of claim 20, wherein said displaced metallic particles are displaced onto a substrate.

22. The process of claim 20, wherein said process is repeated to create a three-dimensional article.

23. The process of claim 21, wherein said displaced metallic particles or substrate are heated via a laser to induce thermal softening.

24. A process for additive manufacturing, wherein metallic particles are projected into a substrate via electrostatic repulsion resulting in the plastic deformation and homogenization of particles into a net mass, said process comprising:
dispensing a plurality of metallic particle into a first plurality of embossments provided on a moveable particle projection belt, wherein each of said plurality of embossments receives a maximum of one metallic particle;
moving said rotating particle projection belt to reveal a second plurality of embossments provided on said moveable particle projection belt;
dispensing a plurality of metallic particles into said second plurality of embossments provided on said moveable particle projection belt, wherein each of said second plurality of embossments receives a maximum of one metallic particle;
selectively electrostatically charging certain of said plurality of metallic particles and a projection plate located adjacent said moveable particle projection belt with charges of the same polarity thereby causing said certain of said metallic particles to be displaced from said rotating particle projection belt via electrostatic repulsion.

25. The process of claim 24, further comprising a substrate and a laser, wherein displaced metallic particles or said substrate are heated via said laser to induce thermal softening.
